(19) United States
(12) Patent Application Publication
(10) Pub. No.: US 2009/0115993 A1
(43) Pub. Date: May 7, 2009

(54) Device and Method for Recording Distance Images

(76) Inventors: Gunter Doemens, Holzkirchen (DE); Peter Mengel, Eichenau (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/992,143

(22) PCT Filed: Sep. 28, 2006
(86) PCT No.: PCT/EP2006/066841

§ 371 Date: Mar. 17, 2008

(30) Foreign Application Priority Data
Sep. 30, 2005 (DE) 10 2005 046 951.5

(51) Int. Cl. G01C 3/08

(52) U.S. Cl. 356/5.01

(57) ABSTRACT

A monitoring device is provided with a detector, by means of which both intensity images and distance images can be recorded. The resolution of the distance image can be increased with the aid of the intensity image. Conversely, the intensity image can be segmented in object-oriented fashion on the basis of the distance image.

The invention relates to a device for recording distance images, comprising a light source that transmits light impulses, a plurality of light receivers and an evaluation unit connected downstream from the light receivers, which unit determines the time-of-flight of the light impulses and generates a distance image on the basis of the times-of-flight.

The invention further relates to methods for processing images of three-dimensional objects.

Such a device and such methods are known from DE 198 33 207 A1. The known device and the known methods are used to generate three-dimensional distance images of three-dimensional objects. In this way, a short-time illumination of the three-dimensional object is carried out with the aid of laser diodes. A sensor comprising a plurality of light receivers picks up the light impulses reflected by the three-dimensional object. By evaluating the reflected light impulses in two integration windows having different integration times and by taking the mean of a plurality of light impulses, three-dimensional distance images can be recorded with a high degree of reliability.

A disadvantage of the known device and of the known methods is that, compared with digital camera systems for taking two-dimensional images, distance images can be recorded only with a relatively low resolution. The structural elements currently available allow only distance images with about 50×50 pixels to be recorded, compared to digital camera systems for intensity images, which generate images in the size order of 1000×1000 pixels.

Conversely, with two-dimensional intensity images, the problem frequently arises that object-orientated image segmentation cannot be carried out because of interference light effects. For example, the casting of a shadow on a three-dimensional object can lead to an image-processing unit no longer recognizing that the fully illuminated area and the shaded area of the three-dimensional object belong to one object and assigning them to different image segments.

Taking the above prior art as the point of departure, the object underlying the invention is therefore to create a device for recording distance images with increased resolution. The object underlying the invention is further to provide methods for processing images of three-dimensional objects, using which methods the three-dimensional resolution of distance images can be improved and using which methods intensity images of three-dimensional objects can be reliably segmented in an object-oriented manner.

The above objects are achieved by the device and the methods having the features of the independent claims. The claims dependent thereon define advantageous embodiments and developments thereof.

The device for recording distance images firstly comprises a plurality of light receivers, with which a determination of the time-of-flight can be achieved. Secondly, a plurality of detector elements are assigned to said light receivers, with which elements an intensity image of the three dimensional object can be generated. Since the intensity image can generally be recorded with a considerably higher resolution than the distance image, additional information about the three-dimensional object is available, with which the resolution of the distance image can be refined. For example, it can be assumed that an area having a uniform gray tone in the image is at the same distance. Even if there is only one single distance measuring point in this gray area, it is possible to generate in the distance image an area which reproduces the contours of the respective area and the distance of the distance measuring point. The resolution of the distance image can thus be increased by using interpolation and equalization methods.

Conversely, intensity images of a three-dimensional object recorded with such a device can be segmented in an object-oriented manner with a high degree of reliability. This is because the additional distance information contained in the distance image can be used to recognize as such areas that are the same distance away and which therefore generally pertain to the same object, even if the areas in the image have different contrast levels or gray tones.

In a preferred embodiment, the detector elements for capturing the intensity images are distributed between the light receivers for capturing the distance image. In such an arrangement, in the subsequent image processing in which the information elements contained in the distance image and in the intensity image are combined, there is no need to take into account any effects caused by different perspectives. On the contrary, it can be assumed that the distance image and the intensity image have been recorded from the same perspective.

In a further preferred embodiment, the light receivers and the detector elements are integrated into a common structural element. With such an integrated structural element, it is possible to create a compact, economical device for recording distance images, in which one optional lens can be used both for the light receivers and for the detector elements. Likewise, one illumination unit can be used both for the light receivers and for the detector elements. Moreover, there is no need to align the detector elements with the light receivers or to determine the relative position of the detector elements in relation to the light receivers by means of a calibration.

Advantageously, the light receivers have a lower spatial resolution than the detector elements. It is thus possible to use the higher resolution available for detector elements of camera systems.

In order to provide the light receivers with a sufficient degree of light intensity, the light impulses transmitted by the light source are concentrated onto a grid of pixels which are projected onto the light receivers by a lens that is disposed in front of the light receivers. As a result of this step, the light emitted by the light source is concentrated on a few points of light and the intensity of the light recorded by the light receivers is increased.

Further features and advantages of the invention will emerge from the description that follows, in which exemplary embodiments of the invention will be explained in detail with the aid of the attached drawing. The figures show:

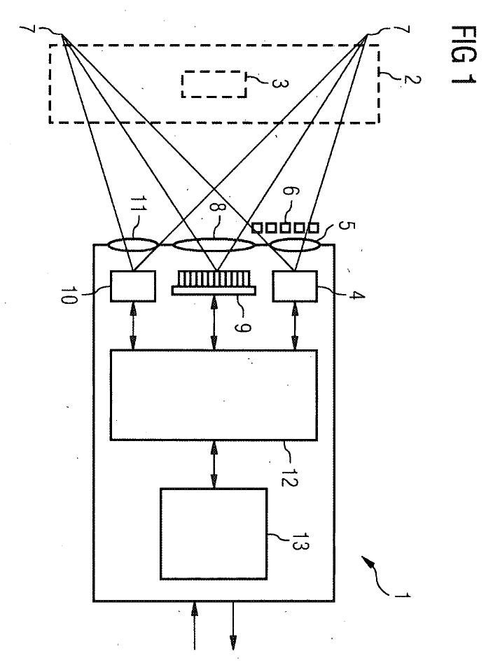

FIG. 1 a block diagram of a device for recording distance images and two-dimensional projections of a three-dimensional object;

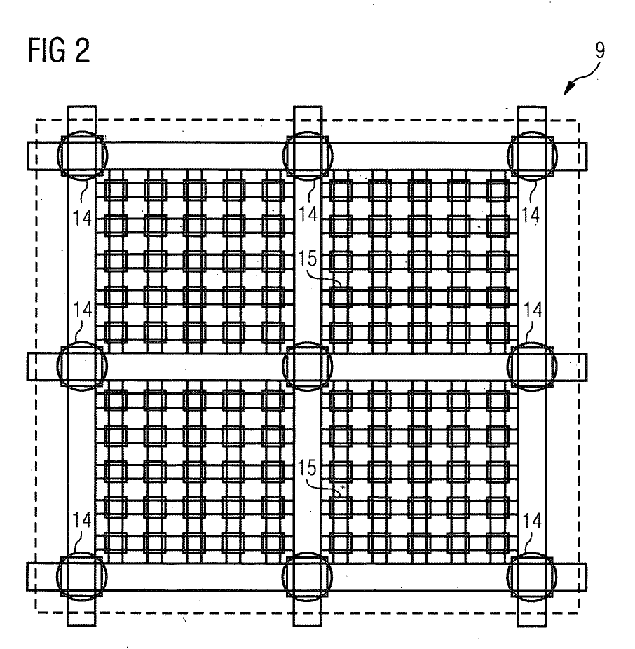

FIG. 2 a view from above onto the detector in the device from FIG. 1.

FIG. 1 shows a monitoring device 1, which serves to monitor a three-dimensional area 2. The monitoring device 1 can be used to monitor a danger zone or to maintain access security. In the three-dimensional area 2 there may be objects 3, the presence of which is designed to be detected by the monitoring device 1. For this purpose, the monitoring device has a pulsed light source 4, which can be one single diode, for example. It should be pointed out that the term light is understood as referring to the whole electro-magnetic wavelength spectrum. The light emanating from the pulsed light source 4 is collimated by means of a lens 5 disposed in front of the pulsed light source 4 and directed onto a diffraction grid 6. The diffraction orders of the light diffracted by the diffraction grid 6 form illumination points 7, which are distributed over the whole of the three-dimensional area 2. The illumination points 7 are projected by an input lens 8 onto a detector 9.

The monitoring device further has a continuous light source 10, which illuminates the whole three-dimensional area 2 by means of a lens 11.

An evaluation unit 12 is connected downstream of the detector 9. The evaluation unit 12 controls the detector 9 and takes a read-out from the detector 9. Furthermore, the evaluation unit 12 also controls the pulsed light source 4 and the continuous light source 10.

Connected downstream of the evaluation unit 12 is an image-processing unit 13, which processes the distance images generated by the evaluation unit 12 and two-dimensional intensity images of the three-dimensional area 2.

FIG. 2 shows a view from above onto the detector 9 of the monitoring device 1 in FIG. 1. The sensitive surface of the detector 9 has light receivers 14, which are manufactured by CMOS technology, for example. With the aid of the light receivers 14, a time-of-flight measurement can be carried out. The light impulses emitted by the pulsed light source 4 scan the three-dimensional area 2 in the illumination points 7. Light reflected on an object 3 in the three-dimensional area 2 arrives at the light receivers 14, which have short integration times in the nanosecond region. As a result of the integration of the light that impacts on the light receivers 14 in two integration windows having integration times of different durations, the time-of-flight from the pulsed light source 4 to the object 3 and back to the respective light receiver 14 can be determined. The distance of the illumination point 7 on the object 3 can be determined directly from the time-of-flight. This type of time-of-flight measurement is known to the person skilled in the art by the term MDSI (=multiple double short time integration), among others. Methods such as PMD (photonic mixing device) can also be used for the time-of-flight measurement.

The detector 9 shown in FIG. 2 includes 3×3 light receivers 14. The space between the light receivers 14 is covered in each case by 5×5 detector elements 15. Just like the light receivers 14, the detector elements 15 are also manufactured using CMOS technology. Whilst the light receivers 14 are used to record a distance image, the detector elements 15 record an intensity image. In this context, an intensity image is defined as both an image that displays the brightness of the object 3, a gray tone image, for example, and also a colored image of the object 3.

It is pointed out that, in a typical embodiment of the detector 9, a grid of about 50×50 light receivers 14 is superimposed on a grid of about 1000×1000 detector elements 15. In such an embodiment, light receivers 14 are located on every twentieth column and line of the grid of detector elements 15.

High resolution distance images can be recorded using the monitoring device 1. For this purpose, the information contained in the intensity image is used to interpolate between the image points of the distance image. It can be assumed, for example, that where a segment of the intensity image has homogeneous brightness, a uniform distance value can also be assigned thereto. Now, if a distance image point is located in the respective segment, an area of the distance image corresponding to the segment of the intensity image can be filled with distance values that correspond to the distance value of the distance image point in the respective segment.

Conversely, an object-oriented segmentation can be carried out on the intensity image. In the segmentation of intensity images, in fact, the problem frequently arises that object areas with different brightness or contrast levels are assigned to different segments. The casting of a shadow on an object can lead to the shaded area being assigned to a certain segment whilst the fully illuminated area is treated as a separate segment. If both the segments have the same distance value, however, both segments can be combined.

The monitoring device 1 offers a number of advantages over conventional monitoring devices.

Unlike light curtains, which consist of a plurality of light barriers each having a transmitter and a receiver, the monitoring device 1 requires only a slight outlay in terms of assembly and is also not susceptible to any disruptive influences due to dirt and foreign particles.

Furthermore, the monitoring device 1 also has low susceptibility to faults and can be operated with low maintenance costs unlike laser scanners, which monitor a three-dimensional area with a rotating laser beam.

The monitoring device 1 is considerably more reliable than CCTV cameras, which allow only two-dimensional processing of gray-tone images, because the reliable functioning of the monitoring device 1 is not dependent on the illumination of the three-dimensional area 2 and the reliability of the monitoring device 1 is likewise not impaired by unwanted surface reflection on the object 3 that is to be captured.

The integration of the light receivers 14 and of the detector elements in the detector 9 further offers the advantage that the monitoring device 1 is compact and can be constructed economically since the lens 11 for the detector 9 can be used by both the light receivers 14 and the detector elements 15. As a result of the fixed spatial relationship between the light receivers 14 and detector elements 15, there is no need to determine the position of the light receivers 14 in relation to the detector elements 15 by means of calibrations.

It should be pointed out that the monitoring device 1 can also be used for driver assistant systems in automotive engineering to capture objects relevant to traffic, for example, vehicles, pedestrians or obstacles.

Furthermore, the monitoring device 1 can also be used to record sequences of images.

1.-13. (canceled)

14. A device for recording distance images, comprising:
a light source to transmit light impulses;
a plurality of light receivers;
an evaluation unit to determine a time-of-flight of the light impulses and to generate a distance image based upon the times-of-flight; and
a plurality of detector elements assigned to the light receivers, wherein the detector elements are readable by the evaluation unit to generate an intensity image.

15. The device as claimed in claim 14, wherein the evaluation unit is connected downstream from the light receivers.

16. The device as claimed in claim 14, wherein the detector elements are distributed between the light receivers.

17. The device as claimed in claim 14, wherein the detector elements are in a fixed three-dimensional relationship with the light receivers.

18. The device as claimed in claim 16, wherein the detector elements are in a fixed three-dimensional relationship with the light receivers.

19. The device as claimed in claim 14, wherein the detector elements and the light receivers are integrated into a structural element.

20. The device as claimed in claim 14, wherein the light receivers have a lower three-dimensional resolution than the detector elements.

21. The device as claimed in claim 17, wherein the light receivers have a lower three-dimensional resolution than the detector elements.

22. The device as claimed in claim 19, wherein the light receivers have a lower three-dimensional resolution than the detector elements.

23. The device as claimed in claim 14, wherein a lens is disposed in front of the light receivers, wherein each respective illumination point impinged upon by light emitted by the light source that emits light impulses is projected onto a light receiver via the lens.

24. The device as claimed in claim 23, wherein the illumination points are generated by a diffraction grid disposed in front of the light source.

25. The device as claimed in claim 14, wherein a separate continuous light source is provided to illuminate the detector elements.

26. The device as claimed in claim 24, wherein a separate continuous light source is provided to illuminate the detector elements.

27. The device as claimed in claim 14, wherein an image processing unit is connected downstream from the evaluation unit, wherein the evaluation unit serves to process the distance image and the intensity image.

28. The device as claimed in claim 27, wherein the image processing unit segments the intensity image based upon the distance image.

29. The device as claimed in claim 27, wherein the image processing unit increases the resolution of the distance image based upon the intensity image.

30. A method for processing images of three-dimensional objects, comprising:
generating a distance image based upon a time-of-flight measurement device and an evaluation unit;
processing the distance image by a an image processing unit; and
segmenting an intensity image recorded by detector elements by the image processing unit based upon the distance image.

31. A method for processing images of three-dimensional objects, comprising:
generating a distance image based upon a time-of-flight measurement device and an evaluation unit;
processing the distance image by a an image processing unit; and
increasing the three-dimensional resolution of the distance image based upon the intensity image.

32. The method as claimed in claim 31, wherein the image processing unit is used for increasing the resolution.
